(19) United States
(12) Patent Application Publication
(10) Pub. No.: US 2021/0331556 A1
(43) Pub. Date: Oct. 28, 2021

(54) ABANDONED CHILD VEHICLE TEMPERATURE SAFETY SYSTEM

(71) Applicant: Rick Tripp, Rock Springs, WY (US)

(72) Inventor: Rick Tripp, Rock Springs, WY (US)

(21) Appl. No.: 16/856,775

(22) Filed: Apr. 23, 2020

(51) Int. Cl. B60H 1/00; B60Q 9/00; B60N 2/00; G08B 21/02; G08B 21/22; G08B 21/24

(52) U.S. Cl. CPC B60H 1/00785; B60Q 9/00; B60N 2/002; B60H 1/00742; G08B 21/22; G08B 21/24; G08B 21/02

(57) ABSTRACT

The disclosure includes a child/pet car safety system. The system includes a 360 degree camera with temperature and humidity sensors and a phone app in accordance with an embodiment of the present disclosure. The attached camera dome recognizes persons or animals in the vehicle. When the vehicle is turned off, the system engages temperature controls to keep remaining persons or animals in the vehicle at a safe and comfortable temperature. The accompanying app notifies users of conditions in the vehicle.

### BACKGROUND OF THE INVENTION

Car seat alarms can be a lifesaver. Quite literally. A conservative average of 37 children die each year in hot vehicles, per some sources and safety organizations regarding kids and cars. There are three primary reasons for the tragedies: An adult forgets a kid in a vehicle; a child somehow gets into the vehicle and gets trapped; and the worst-case scenario is one in which an adult purposely leaves a child in a car and face criminal charges.

According to the American Academy of Pediatrics, heat stroke is the leading cause of non-car crash vehicular death in children under 15. Also worth noting: A child's body heats up three to five times faster than an adult's body does. A car heats up in 10 minutes, and kids can have heat stroke when it's only 57 degrees outside.

Adults should always check the back seat of a vehicle to make sure every child is out of the car before walking away. But that's sometimes easier said then done. And for that reason, it can be worth investing in car seat alarms to alert harried parents that they just ran into the dry cleaner without their child.

### BRIEF DESCRIPTION OF DRAWINGS

FIG. 1 depicts a 360 degree camera with temperature and humidity sensors in accordance with an embodiment of the present disclosure.

FIG. 2 depicts a flow chart of a method for an abandoned child vehicle safety alarm in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### SUMMARY

An abandoned occupant vehicle alarm system includes an alarm controller in communication with a climate control of the vehicle and configured to sound an alarm based on communication indicating an occupant is abandoned inside the vehicle. The system also includes an internal camera adapted with 360 degree face recognition, the internal camera configured in communication with the alarm controller. The system additionally includes a temperature and humidity sensor disposed internally to the vehicle, the temperature and humidity sensor also in communication with the alarm controller. The system further includes an application adapted to communicate a status of the alarm controller to a cellular phone per communication with the internal camera and the temperature and humidity sensor.

Other aspects and advantages of embodiments of the disclosure will become apparent from the following detailed description, taken in conjunction with the accompanying drawings, illustrated by way of example of the principles of the disclosure.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, the term ‘communication’ refers to electronic and electric transfer of information via wires, wireless circuits and electromagnetic signaling. The term ‘controller’ refers to a microcontroller, a state machine and microprocessor and other circuits which produce a predetermined result depending on predetermined inputs. The term ‘climate control,’ refers to the heater and air conditioning system of a vehicle which responds to sensor input and adjustable ranges of temperature and humidity.

The present disclosure includes a car child, disabled persons or pet safety system including a 360 degree camera, tracking app, and temperature and humidity indicator.

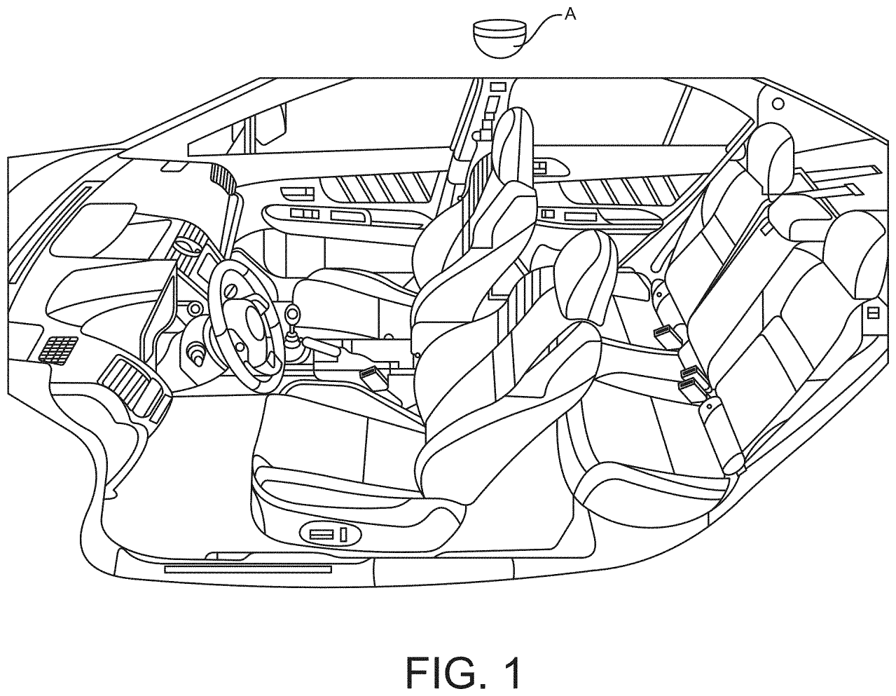

FIG. 1 depicts a 360 degree camera with temperature and humidity sensor connected to phone app in accordance with an embodiment of the present disclosure. Camera is attached to the inside roof of a vehicle. When the vehicle is started, the camera turns on and recognizes all pets or persons in the vehicle. When the vehicle is turned off, the camera will recognize if a participant stays in the vehicle and will emit a clearly audible alarm, similar to an anti-theft alarm. If the alarm does not receive a response through the vehicle controls or app after a certain time, then the vehicle will deactivate the alarm and engage climate controls based on current perceived temperature. Vehicle may lower windows, engage the heater, or otherwise control temperatures in the car to match pre-set temperature preferences while still in a locked position.

The vehicle and app contain a deactivation switch that could be engaged by an autonomous adult remaining in the vehicle. The app also alerts participants outside the vehicle of the conditions inside the vehicle.

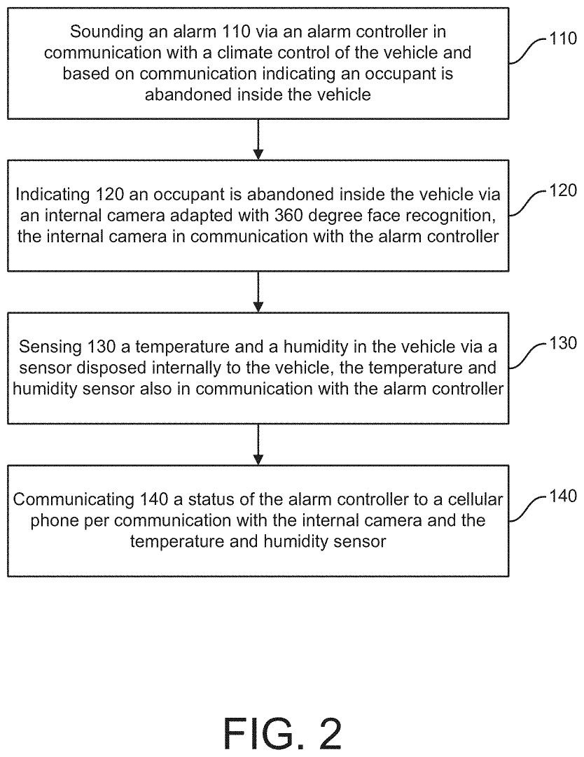

FIG. 2 depicts a flow chart of a method for an abandoned child vehicle safety alarm in accordance with an embodiment of the present disclosure The method includes sounding an alarm 110 via an alarm controller in communication with a climate control of the vehicle and based on communication indicating an occupant is abandoned inside the vehicle. The method also includes indicating 120 an occupant is abandoned inside the vehicle via an internal camera adapted with 360 degree face recognition, the internal camera in communication with the alarm controller. The method additionally includes sensing 130 a temperature and a humidity in the vehicle via a sensor disposed internally to the vehicle, the temperature and humidity sensor also in communication with the alarm controller. The method further includes communicating 140 a status of the alarm controller to a cellular phone per communication with the internal camera and the temperature and humidity sensor.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An abandoned occupant vehicle alarm system, comprising:
a. an alarm controller in communication with a climate control of the vehicle and configured to sound an alarm based on communication indicating an occupant is abandoned inside the vehicle;
b. an internal camera adapted with 360 degree face recognition, the internal camera configured in communication with the alarm controller;
c. a temperature and humidity sensor disposed internally to the vehicle, the temperature and humidity sensor also in communication with the alarm controller; and
d. an application adapted to communicate a status of the alarm controller to a cellular phone per communication with the internal camera and the temperature and humidity sensor.

2. The system of claim 1, wherein an occupant is a child, a disabled person or a pet.

3. The system of claim 1, wherein the internal camera is disposed on an interior ceiling of the vehicle.

4. The system of claim 1, further comprising a memory configured to retain a number of occupants in the vehicle.

5. The system of claim 1, further comprising an alarm deactivation switch located inside the vehicle.

6. The system of claim 1, further comprising an alarm deactivation switch located in the cellular phone.

7. The system of claim 1, wherein the climate control of the vehicle comprises a heater adapted to warm up an internal temperature of the vehicle based on an internal temperature of the vehicle indicated by the temperature and humidity sensor.

8. The system of claim 1, wherein the climate control of the vehicle comprises an air conditioner adapted to cool down an internal temperature of the vehicle based on an internal temperature of the vehicle indicated by the temperature and humidity sensor.

9. The system of claim 1, wherein the climate control of the vehicle comprises a control of a plurality of vehicle windows for opening the windows based on an internal temperature of the vehicle indicated by the temperature and humidity sensor.

10. The system of claim 1, wherein the climate control of the vehicle comprises a control of a plurality of vehicle windows for opening the windows based on an internal humidity of the vehicle indicated by the temperature and humidity sensor.

11. A method of alarming an abandoned occupant vehicle, comprising:
a. sounding an alarm via an alarm controller in communication with a climate control of the vehicle and based on communication indicating an occupant is abandoned inside the vehicle;
b. indicating an occupant is abandoned inside the vehicle via an internal camera adapted with 360 degree face recognition, the internal camera in communication with the alarm controller;
c. sensing a temperature and a humidity in the vehicle via a sensor disposed internally to the vehicle, the temperature and humidity sensor also in communication with the alarm controller; and
d. communicating a status of the alarm controller to a cellular phone per communication with the internal camera and the temperature and humidity sensor.

12. The method of claim 11, further comprising warming up an interior of the vehicle via the climate control of the vehicle based on an internal temperature of the vehicle indicated by the temperature and humidity sensor.

13. The method of claim 11, further comprising cooling down an interior of the vehicle via the climate control of the vehicle based on an internal temperature of the vehicle indicated by the temperature and humidity sensor.

14. The method of claim 11, further comprising opening a plurality of vehicle windows based on an internal temperature and humidity of the vehicle indicated by the temperature and humidity sensor.

15. The method of claim 11, further comprising cooling down an interior of the vehicle via the climate control of the vehicle based on an indication from the internal camera that a child or a disabled person or a pet is abandoned therein.

16. The method of claim 11, further comprising opening a plurality of vehicle windows based on an indication from the internal camera that a child or a disabled person or a pet is abandoned therein.

17. (canceled)

18. (canceled)

19. (canceled)

20. (canceled)
